(19) United States
(12) Patent Application Publication
(10) Pub. No.: US 2024/0159633 A1
(43) Pub. Date: May 16, 2024

(54) MATERIAL TEST SYSTEMS FOR GENERATING STATIC AND DYNAMIC DIAGNOSTIC INFORMATION

(71) Applicant: Illinois Tool Works Inc., Glenview, IL (US)

(72) Inventors: Katherine Levis, Sharon, MA (US); Justin Hawthorne Fry, Hagerstown, MD (US)

(21) Appl. No.: 18/506,694

(22) Filed: Nov. 10, 2023

Related U.S. Application Data
(60) Provisional application No. 63/424,718, filed on Nov. 11, 2022.

(51) Int. Cl. G01N 3/02; G06K 19/06

(52) U.S. Cl. CPC G01N 3/02; G06K 19/06037

(57) ABSTRACT

Disclosed example material testing systems include: a test fixture configured to determine at least one mechanical property of a test specimen; and a processor configured to: in response to a request for a machine readable code, generate the machine readable code by encoding static information about the material testing system and dynamic information representative of a state of the material testing system, wherein the dynamic information comprises at least one of environmental information measured at the test fixture, security information for the material testing system, logged data at the material testing system, load string information for load string equipment installed on the test fixture, a motor voltage measured at the test fixture, a duty cycle of the test fixture, or a cumulative distance traveled by one or more components of the test fixture; and output the machine readable code.

### RELATED APPLICATIONS

The present application claims the benefit of U.S. Provisional Patent Application Ser. No. 63/424,718, filed Nov. 11, 2022, entitled “MATERIAL TEST SYSTEMS FOR GENERATING STATIC AND DYNAMIC DIAGNOSTIC INFORMATION.” The entirety of U.S. Patent Application Ser. No. 63/424,718 is expressly incorporated herein by reference.

### FIELD OF THE DISCLOSURE

This disclosure relates generally to mechanical testing, and more particularly, to material test systems for generating static and dynamic diagnostic information.

### BACKGROUND

Universal testing machines are used to perform mechanical testing, such as compression strength testing or tension strength testing, on materials or components. In the event that errors or problems are encountered with such testing machines, the users or owners often seek the assistance of the machine manufacturer. To this end, testing machine manufacturers may provide support services including phone-based support and/or on-site visits by trained technicians.

### SUMMARY

Material test systems for generating static and dynamic diagnostic information are disclosed, substantially as illustrated by and described in connection with at least one of the figures, as set forth more completely in the claims.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is an example testing device to perform mechanical property testing, in accordance with aspects of this disclosure.

FIG. 2 is a block diagram of an example implementation of the testing device of FIG. 1.

FIG. 3 illustrates an example user interface that may be displayed by the material testing system including a machine readable code that is accessible to the computing device.

FIG. 4 is a flowchart representative of example machine readable instructions which may be executed by the example material testing system of FIGS. 1 and/or 2 to generate and output a machine readable code including static and/or dynamic information about the material testing system.

The figures are not necessarily to scale. Wherever appropriate, similar or identical reference numerals are used to refer to similar or identical components.

### DETAILED DESCRIPTION

When a conventional mechanical testing device is not operating as desired, the operator (or other personnel associated with the testing device) may contact a manufacturer or distributor of the testing device in an attempt to troubleshoot the operational issue. For troubleshooting conventional testing systems, contact between the service personnel and the testing device operator often involves multiple, separate contacts such as phone calls, emails, text chats, and/or other steps to provide the complete set of information needed by the service personnel to resolve the issue to the satisfaction of the operator. Such multiple steps can be a source of frustration to the operator and/or reduces uptime of the testing device for performing mechanical tests. Furthermore, if a resolution of the issue cannot be accomplished with remote service personnel, an in-person service visit may be required, which increases the service costs to the owner of the testing device and/or to the provider of the support services.

Disclosed example systems and methods improve the ability of a test system owner or operator to diagnose common problems encountered by material testing systems at lower cost and/or in less time. In some examples, the user of the test system accesses static information and dynamic information from the material testing system using a portable computing device (e.g., smartphone, tablet computer, etc.). The static information may include information about the test system that is substantially constant, such as a model number of the material testing system, a serial number of the material testing system, a system identifier (e.g., a combination of the model and serial number of the material testing system), a type of material testing system, a class of material testing system, a description of the material testing system, and/or any other substantially constant information about the material testing system. The dynamic information may include information representative of a state of the material testing system, such as an error code (e.g., a code detected by the system) generated at the material testing system, an error message (e.g., a message generated in response to a problematic user action) at the material testing system, environmental information measured at the material testing system, security information for the material testing system, logged data at the material testing system, load string information for load string equipment installed on the material testing system, a software version on the material testing system, diagnostic information detected on the material testing system, a motor voltage measured at the material testing system, a duty cycle of the material testing system, and/or a cumulative distance traveled by one or more components of the material testing system. The static and/or dynamic information may be used for faster and/or easier troubleshooting of the material testing system.

Disclosed example material testing systems include: a test fixture configured to determine at least one mechanical property of a test specimen; and a processor configured to: in response to a request for a machine readable code, generate the machine readable code by encoding static information about the material testing system and dynamic information representative of a state of the material testing system, wherein the dynamic information comprises at least one of environmental information measured at the test fixture, security information for the material testing system, logged data at the material testing system, load string information for load string equipment installed on the test fixture, a motor voltage measured at the test fixture, a duty cycle of the test fixture, or a cumulative distance traveled by one or more components of the test fixture; and output the machine readable code.

In some example material testing systems, the static information includes at least one of a model number of the material testing system, a serial number of the material testing system, an identifier of the material testing system, or a description of the material testing system. In some example material testing systems, the dynamic information further includes at least one of an error code generated at the material testing system, logged data at the material testing system, a software version on the material testing system, or diagnostic information detected on the material testing system. In some example material testing systems, the test fixture comprises at least one of a crosshead, an actuator, or material fixturing. In some example material testing systems, the machine readable code comprises a QR code or a barcode.

Disclosed example methods to provide information from a material testing system involve: in response to a request for a machine readable code, generating the machine readable code using a processor of the material testing system by encoding static information about the material testing system and dynamic information representative of a state of the material testing system, wherein the dynamic information comprises at least one of environmental information measured at the test fixture, security information for the material testing system, logged data at the material testing system, load string information for load string equipment installed on the test fixture, a motor voltage measured at the test fixture, a duty cycle of the test fixture, or a cumulative distance traveled by one or more components of the test fixture; and outputting the machine readable code using the material testing system.

In some example methods, the outputting involves displaying the machine readable code on a display. In some example methods, the outputting involves transmitting the machine readable code via at least one of RFID, near field communications (NFC) transmissions, close proximity communications, or ultrasonic communications.

In some example methods, the static information includes at least one of a model number of the material testing system, a serial number of the material testing system, an identifier of the material testing system, or a description of the material testing system. In some example methods, the dynamic information further includes at least one of an error code generated at the material testing system, a software version on the material testing system, or diagnostic information detected on the material testing system.

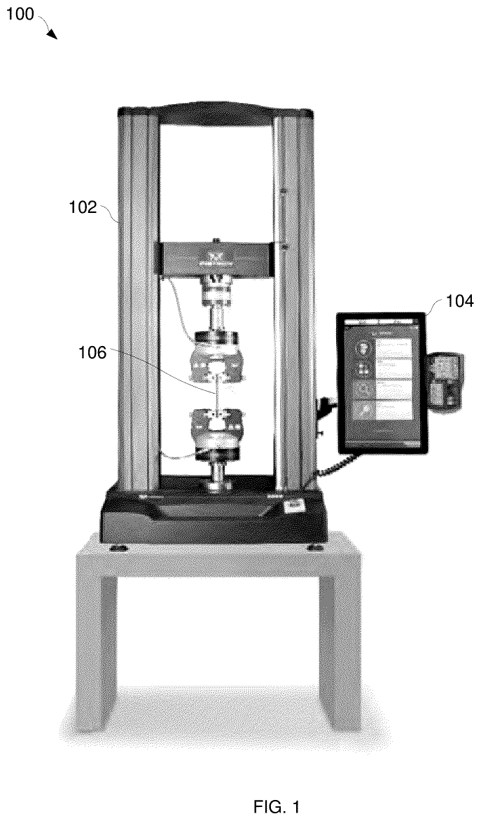

FIG. 1 is an example material testing system 100 to perform mechanical property testing. The example material testing system 100 may be, for example, a universal testing system capable of static mechanical testing. The material testing system 100 may perform, for example, compression strength testing, tension strength testing, shear strength testing, bend strength testing, deflection strength testing, tearing strength testing, peel strength testing (e.g., strength of an adhesive bond), and/or any other compressive, tensile, torsion, thermal, and/or impact testing. Additionally or alternatively, the material testing system 100 may perform dynamic testing.

The example material testing system 100 includes a test fixture 102 and a computing device 104 communicatively coupled to the test fixture 102. The test fixture 102 applies loads to a material under test 106 and measures the mechanical properties of the test, such as displacement of the material under test 106 and/or force applied to the material under test 106.

The example computing device 104 may be used to configure the test fixture 102, control the test fixture 102, and/or receive measurement results from the test fixture 102 for processing, display, reporting, and/or any other desired purposes.

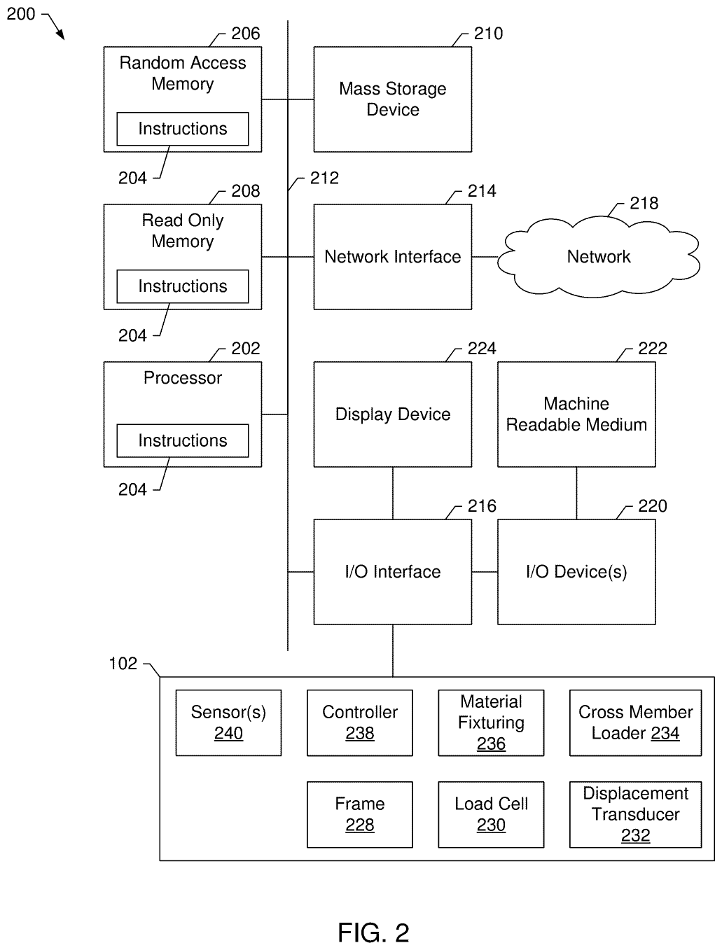

FIG. 2 is a block diagram of an example computing system 200 that may be used to implement the material testing system 100 of FIG. 1. The example material testing system 100 of FIG. 2 includes the test fixture 102 and the computing device 104. The example computing device 104 may be a general-purpose computer, a laptop computer, a tablet computer, a mobile device, a server, an all-in-one computer, and/or any other type of computing device.

The example computing system 200 of FIG. 2 includes a processor 202. The example processor 202 may be any general purpose central processing unit (CPU) from any manufacturer. In some other examples, the processor 202 may include one or more specialized processing units, such as RISC processors with an ARM core, graphic processing units, digital signal processors, and/or system-on-chips (SoC). The processor 202 executes machine readable instructions 204 that may be stored locally at the processor (e.g., in an included cache or SoC), in a random access memory 206 (or other volatile memory), in a read only memory 208 (or other non-volatile memory such as FLASH memory), and/or in a mass storage device 210. The example mass storage device 210 may be a hard drive, a solid state storage drive, a hybrid drive, a RAID array, and/or any other mass data storage device.

A bus 212 enables communications between the processor 202, the RAM 206, the ROM 208, the mass storage device 210, a network interface 214, and/or an input/output interface 216.

The example network interface 214 includes hardware, firmware, and/or software to connect the computing system 200 to a communications network 218 such as the Internet. For example, the network interface 214 may include IEEE 802.X-compliant wireless and/or wired communications hardware for transmitting and/or receiving communications.

The example I/O interface 216 of FIG. 2 includes hardware, firmware, and/or software to connect one or more input/output devices 220 to the processor 202 for providing input to the processor 202 and/or providing output from the processor 202. For example, the I/O interface 216 may include a graphics processing unit for interfacing with a display device, a universal serial bus port for interfacing with one or more USB-compliant devices, a FireWire, a field bus, and/or any other type of interface. The example material testing system 100 includes a display device 224 (e.g., an LCD screen) coupled to the I/O interface 216. Other example I/O device(s) 220 may include a keyboard, a keypad, a mouse, a trackball, a pointing device, a microphone, an audio speaker, a display device, an optical media drive, a multi-touch touch screen, a gesture recognition interface, a magnetic media drive, and/or any other type of input and/or output device.

The example computing system 200 may access a non-transitory machine readable medium 222 via the I/O interface 216 and/or the I/O device(s) 220. Examples of the machine readable medium 222 of FIG. 2 include optical discs (e.g., compact discs (CDs), digital versatile/video discs (DVDs), Blu-ray discs, etc.), magnetic media (e.g., floppy disks), portable storage media (e.g., portable flash drives, secure digital (SD) cards, etc.), and/or any other type of removable and/or installed machine readable media.

The example material testing system 100 of FIG. 1 further includes the test fixture 102 coupled to the computing system 200. In the example of FIG. 2, the test fixture 102 is coupled to the computing device via the I/O interface 216, such as via a USB port, a Thunderbolt port, a FireWire (IEEE 1394) port, and/or any other type serial or parallel data port. In some other examples, the test fixture 102 is coupled to the network interface 214 via a wired or wireless connection, either directly or via the network 218.

The test fixture 102 of FIG. 2 includes a frame 228, a load cell 230, a displacement transducer 232, a cross member loader 234, material fixtures 236, a controller 238, and sensor(s) 240. The test fixture 102 may include any number of other transducers, based on the type(s) of mechanical tests that the test fixture 102 is capable of performing. Other test fixtures may be dynamic test fixtures and/or include different test equipment, while including appropriate transducers that produce test data and may be controlled via the computing device 104. The example test fixture 102 may include actuators, load strings, fixturing, structural members, and/or any other components to facilitate compression strength testing, tension strength testing, shear strength testing, bend strength testing, deflection strength testing, tearing strength testing, peel strength testing (e.g., strength of an adhesive bond), and/or any other compressive, tensile, torsion, thermal, and/or impact testing, and/or dynamic testing.

The frame 228 provides rigid structural support for the other components of the test fixture 102 that perform the test. The load cell 230 measures force applied to a material under test by the cross member loader 234 (e.g., an electric motor, a hydraulic pump, a pneumatic actuator, and/or other actuator, which may be supported by a crosshead and/or other movable member(s) coupling the actuator to the specimen) via the material fixtures 236. The cross member loader 234 applies force to the material under test, while the material fixtures 236 (e.g., grips or other fixturing) grasp or otherwise couple the material under test to the cross member loader 234. Example material fixtures 236 include grips, jaws, jigs, anvils, compression platens, or other types of fixtures, depending on the mechanical property being tested and/or the material under test.

The example controller 238 communicates with the computing device 104 to, for example, receive test parameters from the computing device 104 and/or report measurements and/or other results to the computing device 104. For example, the controller 238 may include one or more communication or I/O interfaces to enable communication with the computing device 104. The controller 238 may control the cross member loader 234 to increase or decrease applied force, control the fixture(s) 236 to grasp or release a material under test, and/or receive measurements from the displacement transducer 232, the load cell 230, and/or any other transducer(s).

The example test fixture 102 may further include one or more sensors 240 to measure conditions in and/or around the test fixture 102 and/or to monitor or measure activity by the test fixture 102. For example, the sensor(s) 240 may include: environmental sensor(s) to measure an ambient temperature, humidity, and/or any other condition(s) around the test fixture 102 that may affect operation; temperature sensors to measure component temperatures; voltage sensors to measure motor voltage, power supply input and/or output voltages, and/or other voltages in the test fixture 102, duty cycles of components in the test fixture 102, and/or other voltage-derived data; current sensors to measure motor current, power supply input and/or output currents, and/or other electrical currents in the test fixture 102, duty cycles of components, and/or other current-derived data; distance and/or proximity sensors to measure distances traveled by components in the test fixture 102 (e.g., distances traveled by grips, by a crosshead, etc.); and/or any other types of sensors for determining relevant information about the test fixture 102.

In addition to detecting conditions in and/or around the test fixture 102 using sensors, the example processor 202 may monitor for other conditions or states of the test fixture 102 and/or computing system 200. For example, the processor 202 may monitor and/or determine error codes (e.g., codes detected or generated by software) generated at the material testing system, error messages (e.g., a message generated by software in response to a problematic user action) at the material testing system, security information for the material testing system, logged data at the material testing system, load string information for load string equipment installed on the material testing system, a software version on the material testing system, diagnostic information detected on the material testing system, and/or any other software-detected information.

In some examples, one or more conditions or states of the test fixture 102 and/or the computing system 200 may be detected with a combination of sensors and software.

When a user (e.g., operator) encounters a problem with the material testing system 100, the user may access static and/or dynamic information about the material testing system 100 to assist in resolving the problem.

To access the static and/or dynamic information, the user may make a specific request via the I/O interface 216, which may cause the material testing system 100 to generate a visible code, transmit a radiofrequency (RF) transceiver to receive an RF transmission, and/or via any other method to output a machine-readable code that can be accessed by another computing device. Example visible codes include one-dimensional or two-dimensional barcodes (e.g., QR codes or similar). Example RF transmissions may include scanning an RFID tag or reader, communicating via near field communications (NFC) transmissions, and/or any other close proximity communications, ultrasonic communications, and/or any other wireless communications.

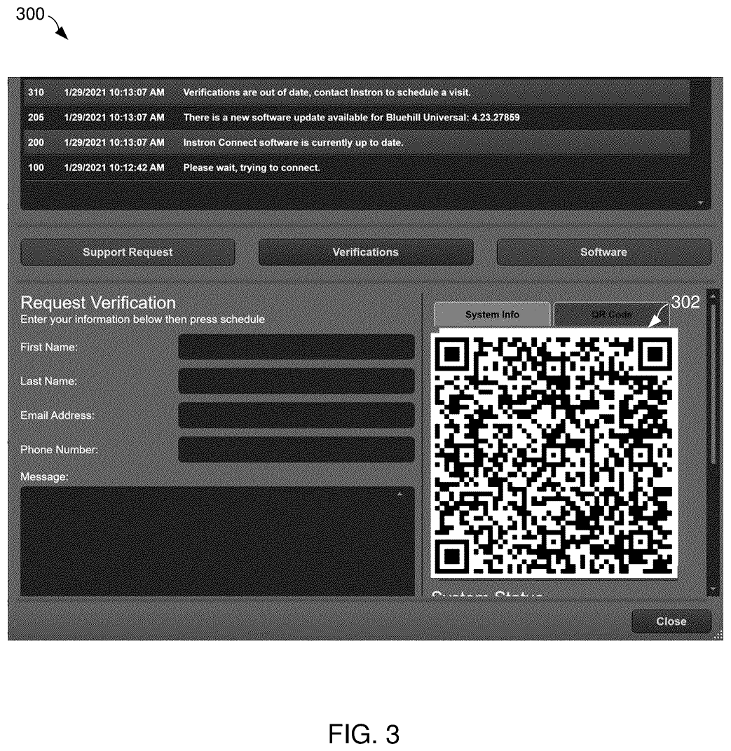

In some examples, the material testing system 100 generates the machine readable code to include static information about the material testing system 100 and dynamic information representative of a state of the material testing system 100. FIG. 3 illustrates an example user interface 300 that may be displayed by the material testing system 100 (e.g., via the display device 224 of FIG. 2) including a machine readable code 302 that is accessible to the computing device 304. The material testing system 100 may generate the machine readable code 302 based on current dynamic information, and update the machine readable code 302 when the dynamic information changes. In some examples, the material testing system 100 selects relevant dynamic information for encoding in the machine readable code 302 based on a context in which the code 302 is generated, such as for a request for troubleshooting, a detected error or problem in the material testing system 100, and/or for any other context.

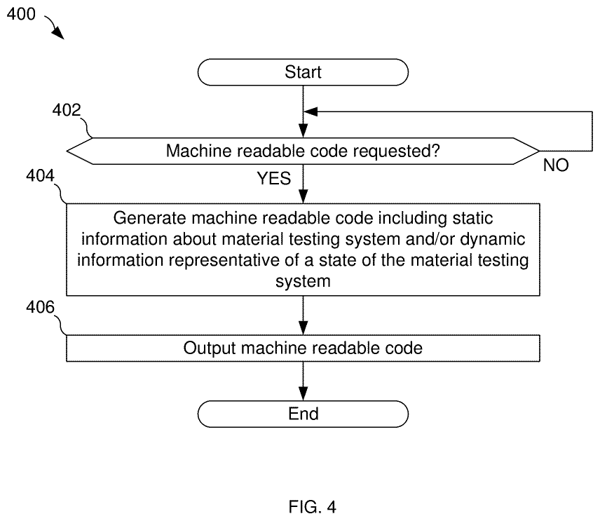

FIG. 4 is a flowchart representative of example machine readable instructions 400 which may be executed by the example material testing system 100 of FIGS. 1-3 to generate and output a machine readable code including static and/or dynamic information about the material testing system 100. The example instructions 400 may be executed in parallel with, or as part of, a user interface or test control software executed on the material testing system 100 via the computing system 200.

At block 402, the example material testing system 100 (e.g., via the processor 202) determines whether a machine readable code is requested. For example, a user interface of the material testing system 100 may receive an input requesting the machine readable code, such as by navigating to a troubleshooting interface or other portion of a menu or navigable interface on which a visible machine readable code can be displayed (e.g., a QR code, a barcode, etc.). Additionally or alternatively, the machine readable code may be requested via an NFC transceiver receiving a request from the computing device 304.

If a machine readable code is not requested (block 402), control returns to block 402 to await a request for a machine readable code. When a machine readable code is requested (block 402), at block 404 the processor 202 generates a machine readable code by including static information about the material testing system 100 and dynamic information representative of a state of the material testing system 100.

Example static information that may be included in the machine readable code includes information about the test system that is substantially constant, such as a model number of the material testing system 100, a serial number of the material testing system 100, a system identifier (e.g., a combination of the model and serial number of the material testing system), a type of material testing system 100, a class of material testing system 100, a description of the material testing system 100, and/or any other substantially constant information about the material testing system 100. Example dynamic information that may be included in the machine readable code includes information representative of a state of the material testing system 100, such as an error code (e.g., a code detected by the system) generated at the material testing system 100, an error message (e.g., a message generated in response to a problematic user action) at the material testing system 100, environmental information measured at the material testing system 100, security information for the material testing system 100 (e.g., user authorization, firewall settings, open firewall ports, changes to a firewall configuration from a prior connection, a default firewall configuration), logged data at the material testing system 100, load string information for load string equipment installed on the material testing system 100, a software version on the material testing system 100, diagnostic information detected on the material testing system 100, a motor voltage measured at the material testing system 100, a duty cycle (e.g., average or typical duration of use per period of time) of the material testing system 100, and/or a cumulative distance traveled by one or more components (e.g., crosshead, grips, etc.) of the material testing system 100.

In some examples, the processor 202 may select subsets of available static information and/or subsets of available dynamic information on the material testing system 100 based on contextual information and/or the content of the available dynamic information. For example, the processor 202 may select measurements, log entries, error messages, and/or other subsets of dynamic information for inclusion in the machine readable code based on the presence of certain error messages. For example, if a communications error code is present, the processor 202 may select log entries, messages, and/or error codes related to network communications. In other examples, if a hardware or software failure is detected, the processor 202 may include sensor measurements for component and/or environmental conditions.

The processor 202 encodes the selected static information and/or dynamic information into a machine readable code based on the request. For example, the processor 202 may generate and display a one-dimensional or two-dimensional barcode for display on a user interface, or generate one or more messages for transmission via an NFC, RFID, RF, and/or other wireless communication. At block 406, the processor 202 outputs the machine readable code. The example instructions 400 then end.

The present methods and systems may be realized in hardware, software, and/or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may include a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein. As used herein, the term “non-transitory machine-readable medium” is defined to include all types of machine readable storage media and to exclude propagating signals.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

1. A material testing system, comprising:
a test fixture configured to determine at least one mechanical property of a test specimen; and
a processor configured to:
in response to a request for a machine readable code, generate the machine readable code by encoding static information about the material testing system and dynamic information representative of a state of the material testing system, wherein the dynamic information comprises at least one of environmental information measured at the test fixture, security information for the material testing system, logged data at the material testing system, load string information for load string equipment installed on the test fixture, a motor voltage measured at the test fixture, a duty cycle of the test fixture, or a cumulative distance traveled by one or more components of the test fixture; and
output the machine readable code.

2. The material testing system as defined in claim 1, wherein the static information comprises a model number of the material testing system.

3. The material testing system as defined in claim 1, wherein the static information comprises a serial number of the material testing system.

4. The material testing system as defined in claim 1, wherein the static information comprises an identifier of the material testing system.

5. The material testing system as defined in claim 1, wherein the static information comprises a description of the material testing system.

6. The material testing system as defined in claim 1, wherein the dynamic information further comprises an error code generated at the material testing system.

7. The material testing system as defined in claim 1, wherein the dynamic information further comprises a software version on the material testing system.

8. The material testing system as defined in claim 1, wherein the dynamic information further comprises diagnostic information detected on the material testing system.

9. The material testing system as defined in claim 1, wherein the test fixture comprises at least one of a crosshead, an actuator, or material fixturing.

10. The material testing system as defined in claim 1, wherein the machine readable code comprises a QR code or a barcode.

11. A method to provide information from a material testing system, the method comprising:
in response to a request for a machine readable code, generating the machine readable code using a processor of the material testing system by encoding static information about the material testing system and dynamic information representative of a state of the material testing system, wherein the dynamic information comprises at least one of environmental information measured at the test fixture, security information for the material testing system, logged data at the material testing system, load string information for load string equipment installed on the test fixture, a motor voltage measured at the test fixture, a duty cycle of the test fixture, or a cumulative distance traveled by one or more components of the test fixture; and
outputting the machine readable code using the material testing system.

12. The method as defined in claim 11, wherein the outputting comprises displaying the machine readable code on a display.

13. The method as defined in claim 11, wherein the outputting comprises transmitting the machine readable code via at least one of RFID, near field communications (NFC) transmissions, close proximity communications, or ultrasonic communications.

14. The method as defined in claim 11, wherein the static information comprises a model number of the material testing system.

15. The method as defined in claim 11, wherein the static information comprises a serial number of the material testing system.

16. The method as defined in claim 11, wherein the static information comprises an identifier of the material testing system.

17. The method as defined in claim 11, wherein the static information comprises a description of the material testing system.

18. The method as defined in claim 11, wherein the dynamic information further comprises an error code generated at the material testing system.

19. The method as defined in claim 11, wherein the dynamic information further comprises a software version on the material testing system.

20. The method as defined in claim 11, wherein the dynamic information further comprises diagnostic information detected on the material testing system.
